(19) United States
(12) Patent Application Publication
(10) Pub. No.: US 2010/0030566 A1
(43) Pub. Date: Feb. 4, 2010

(54) Magazine Collectable With Content Link

(75) Inventor: James H. Eisenberg, Carlsbad, CA (US)

Correspondence Address: FISH & ASSOCIATES, PC;ROBERT D. FISH, 2603 Main Street, Suite 1000, Irvine, CA, 92614-6232, US

(73) Assignee: SECTION 1 LLC, Solana Beach, CA (US)

(21) Appl. No.: 12/184,799

(22) Filed: Aug. 1, 2008

(51) Int. Cl. G06Q 30/00

(52) U.S. Cl. 705/1

(57) ABSTRACT

A copy of a magazine issue can be packaged with a collectible object. The collectible object preferably comprises a link pointing to on-line content that corresponds to the issue's printed content. Contemplated collectibles include collectible cards having a rendering of a cover of the issue on surface of the card. Links can include URLs, unique codes associated with a subscriber, or computer readable codes.

### FIELD OF THE INVENTION

The field of the invention is providing access to on-line magazine content through a collectible.

### BACKGROUND

Individuals who enjoy collecting issues of magazines or issues of other periodicals often encounter numerous problems with their collections. One such problem includes the excessive volume consumed by a collection due to the bulky nature of the printed copies of the issues. For example, an individual could store copies of back issues in boxes numbering in the tens, hundreds, or even more. A large collection of storage boxes take up a substantial space in the individual's home. An additional problem arises when the individual wishes to review the printed content of a specific issue. The individual must locate a copy of the printed issue, remove the copy from its box, and possibly remove the copy from its protective covering. At any point in the process of retrieving the issue copy, the copy could become damaged in a manner where the collectible's value decreases substantially. Ideally, an individual should be able to collect an object associated with an issue of a magazine where the object provides access to the issue's content while also ensuring that the object retains is collectible value during use.

Others have provided access to content via a magazine insert that includes a universal resource locator (URL) pointing point to the magazine's web site. For example, a subscription postcard is often included in magazines as an advertisement and includes a URL to the magazine's website (e.g., www.wired.com, www.si.com, www.bgh.com, etc. . . . ). However, the URLs on such inserts do not offer a link to on-line content that matches the printed content of the issue in which the postcard was found.

Another example includes U.S. Patent Publication 2003/037067 to Walker et al. titled “Method and Apparatus for Distributing Supplemental Information Related to Articles”. Walker describes including hyperlink footnotes within articles of a printed media. The hyperlinks merely provide on-line access to additional or supplemental content relating to the corresponding article. However, Walker and others have failed to appreciate there is a need for a collectible object that provides access to on-line content that substantially corresponds to the printed content of a magazine issue.

The Walker reference and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply. Unless a contrary intent is apparent from the context, all ranges recited herein are inclusive of their endpoints, and open-ended ranges should be interpreted to include only commercially practical values.

Thus, there is still a need for collectibles that provide access to content that corresponds to printed content of a magazine issue.

### SUMMARY OF THE INVENTION

The present invention provides apparatus, systems and methods in which a magazine issue is distributed by sending a package to an individual where the package comprises a copy of the issue and a collectible. The collectible preferably comprises a link that provides a pointer to on-line accessible content that corresponds to printed content of the magazine issue or a previous issue. The collectible is preferably an object that is easily removed from the issue copy and can comprise a card, poster, or even a substantially three dimensional object (e.g., a toy, model, figurine, etc. . . . ).

As used herein, the term “magazine” should be broadly interpreted to included periodicals that are published on a substantially predictable schedule. Periodicals can include comic books, newspapers, traditional magazines, quarterlies, newsletters, or other predictably released published works. An advertising brochure or pamphlet would not be considered a magazine because it would generally be published once at a time unknown to the public. Magazines can be published daily, weekly, bi-weekly, monthly, every six weeks, quarterly, or on other periodic schedules. An issue of a magazine represents all the physical copies of an instance of the magazine released substantially on the same date. Additionally, a magazine is considered to represent a collection of all previous, current, and future issues of the magazine as opposed to a single issue. Example magazines include TV Guide™, Sports Illustrated™, Better Homes and Gardens™, The New York Times™, or Playboy™. Examples of an issue of a magazine include the May 2008 copy of Better Homes and Gardens, the Jul. 27, 2008, Sunday edition of the New York Times, or the Jul. 19, 1999, issue of Sports Illustrated (Volume 91, Issue 3).

A “collectible” is considered to be a separate object with respect to a copy of a magazine issue and is preferably manufactured or designed as an object to be collected.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of an issue of a magazine distributed with a collectible card having a link to on-line content.

FIG. 2 is a schematic of the collectible card of FIG. 1 where the link is used to access on-line content via a web page.

### DETAILED DESCRIPTION

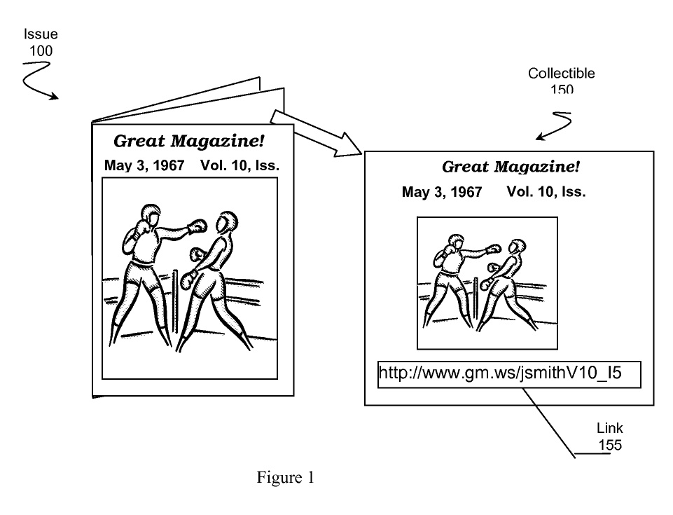

In FIG. 1, issue 100 is distributed with a collectible 150. Issue 100 represents a physical copy of an issue of a magazine. Issue 100 includes printed content on a physical media where the printed content can comprise images, text, advertisements, stories, articles, or other content. Preferably collectible 150 is packaged with issue 100 for distribution to individuals and includes link 155 that points to on-line content that corresponds to the printed content of issue 100. Issue 100 can be printed using well known techniques or those yet to be invented while still falling with the scope of the inventive subject matter.

Collectible 150 preferably comprises a substantially flat, planar object where the length and the width of the object exceed the object's thickness by at least a factor of ten. Example planar objects include cards, playing cards, postcards, posters, CDs, or other thin objects. In a preferred embodiment, collectible 150 comprises card stock. Manufacturing collectible 150 out of card stock allows collectible 150 to retain its shape and be robust to last while stored in a collection. Preferred card stock has a pound weight of at least 80#, and more preferably at least 160#. It is also contemplated that acid free card stock can be used be to ensure collectible 150 would endure for extended periods of time. However, any suitable card stock can be used as desired by those publishing issue 100.

A preferred collectible card is sized and dimensions to fit within existing protective sleeves suitable for other collectible cards including base ball cards, or collectible trading card games. Typical dimensions of a collectible card range in width from about 2 to 3 inches and a range in length from about 3 to 6 inches, and have preferred width and length of about 2.5 inches and about 3.5 inches, respectively. The thickness of a collectible card can vary as desired or as a function of the card stock used to manufacture the card. Preferred thicknesses are at least 20 points (a thousandth of an inch), and more preferably at least 55 points.

In a preferred embodiment, collectible 150 includes a rendering of a cover of issue 100, or a previous published issue, on a surface of collectible 150. For example, a collectible card can be inserted within an issue copy of Sports Illustrated. The collectible card can include a copy of the cover of the issue. Including the cover of issue 100 or a cover of a previous issue on collectible 150 aids collectors in easily identifying to which issue collectible 150 corresponds. It is also contemplated that the surfaces of collectible 150 can include additional information or content other than a rendering of the cover of issue 100. Additional information can include promotional information, advertisements, statistics of the issue, or other content.

Although collectible 150 preferably comprises a planar object, it is also contemplated that collectible 150 can include non-planar objects that are substantially three dimensional. Contemplated non-planar objects include figurines, toys, models, jewelry, or other items. For example, Sport Illustrated could package a figurine with copies of an issue where the figurine is modeled after a prominent athlete featured in the issue or in a previous issue. As used herein, the term “package” is considered to include the concept that an individual purchasing a first item of is entitled to a second item. In this sense, the two items are “packaged” together, whether logically packaged together or physically packaged together.

Collectible 150 is preferably packaged with issue 100 for distribution. In embodiments where collectible 150 comprises a collectible card, the card can be merely inserted into the pages of issue 100, or the card can be removeably affixed to a portion of issue 100. For example, a card can be attached to a page of issue 100 using a sticky or tacky substance that allows the card to be removed without damaging the card or the page. In other embodiments, issue 100 and collectible 150 can be packaged together in a bag or otherwise bound together to ensure collectible 150 is not lost during distribution.

Although issue 100 and collectible 150 are packaged together, it is also contemplated that collectible 150 could be sent to an individual separately issue 100. For example, an individual could order previously published issues of a magazine where the copies are sent separately from the collectibles associated with the issues. In some embodiments, sending collectible 150 can lag behind sending issue 100 by a week, a month, or longer.

It is also contemplated that there can be more than one of collectible 150 associated with issue 100. Issue 100 can be packaged with multiple, preferably different, collectible 150. Additionally, different versions of collectible 150 can be packaged with separate copies of issue 100 where a first individual would receive a first version of collectible 150 and a second individual would received a second version of collectible 150 different than the first collectible.

In some embodiments, collectible 150 can be a member of a set, preferably associated with the magazine, issue 100, or any previous issue. Distributing members of a set increases the collectible nature of collectible 150 and can drive additional purchases of issue 100. Consider for example, the famed swimsuit issue of Sports Illustrated. Sports Illustrated could package a copy of the issue with a single collectible card or possibly a figurine depicting the likeness of a single swimsuit model from the issue. A complete set of collectible 150 would comprise a card for each featured swimsuit model. An avid collector would likely seek to purchase additional copies of the issue to obtain the additional members of the set for collecting or for trade with other collectors.

Furthermore, collectible 150 can be distributed according a rarity schedule (e.g., common, uncommon, rare, ultra rare, etc. . . . ). For example, most individuals would receive a common version of collectible 150, a smaller number of individuals would receive an uncommon version, and yet a smaller, lucky few would receive a rare version of collectible 150. Distributing collectibles according to a rarity schedule can also increase the collectible nature of collectible 150 due to the scarcity of some of the versions of collectible 150.

Issue 100 can be distributed in any suitable manner. Preferred acceptable methods of distribution copies of issue 100 to individuals include sending a package having issue 100 and collectible 150 to subscribers of the magazine. The package can also be sent through known distribution channels or placed on sale in traditional venues. In some embodiments, a subscriber could subscribe to only the on-line version of the magazine. In which case, collectible 150 can be sent to the individual separately.

Collectible 150 preferably includes link 155 that can be used by an individual to access on-line content that corresponds to the printed content of issue 100 or even the printed content of a previous issue, where at least some of the content is identical. In a preferred embodiment, the on-line content identically corresponds at least 50% of the printed content, more preferably 90% of the printed content, and yet more preferably 100% of the printed content.

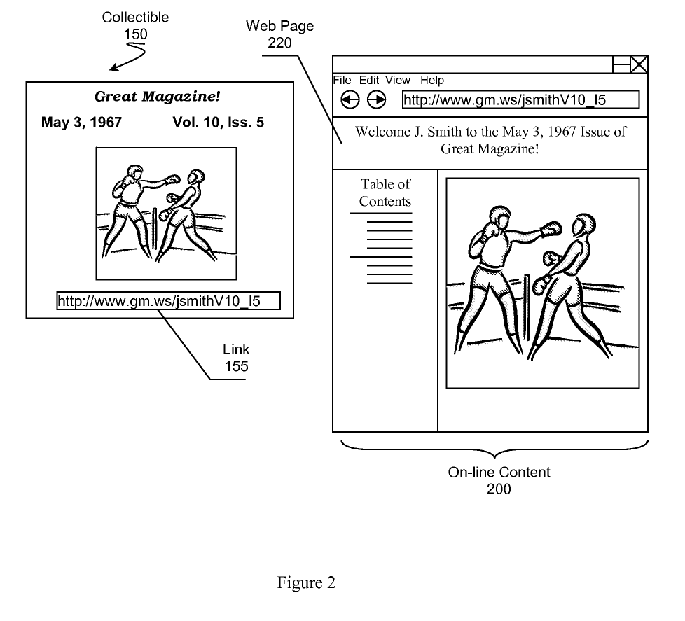

In FIG. 2, an individual uses link 155 to access web page 220 displaying on-line content 200. On-line content 200 can correspond to the printed content of a current issue of a magazine or a previously published issue of the magazine.

As illustrated in FIG. 2, link 155 can include a URL that can be typed into a browser to access on-line content 200. Link 155 can also comprise one or more computer readable codes located on collectible 150 or embedded within collectible 150. Computer readable codes can include bar codes, RFID tags, magnetic strips, encoded text, or other codes that can be automatically recognized by a computer. A sensor coupled to a computer can read the code (e.g., a laser scanner, an RFID reader, magnetic strip reader, or an optical scanner) to capture data that can be converted by the computer into a network address of the on-line content. Contemplated network addresses include URLs, IP addresses, domain names, or other identifiers that can be used to access on-line content. Regardless of the implementation of link 155, link 155 is preferably accessible without requiring an individual to remove collectible 150 from a protective covering.

Link 155 can also include a code comprising one or more alphanumeric digits (e.g., “11181991”, “AX45$6_?”, etc. . . . ). An individual can browse to the web site of the magazine (e.g., www.sivault.com, www.wired.com, etc. . . . ) and enter the code into an appropriate interface to access on-line content 200.

In an embodiment where an individual is a subscriber, it is specifically contemplated that link 155 can comprise a unique code assigned specifically to the single subscriber. As shown, for example in FIG. 2, link 155 represents a customized URL that encodes a subscriber's name and a specific issue of the magazine. Such an approach allows the publisher of the magazine to track subscriber interest and can be used for advertising purposes or other revenue generating purposes. One skilled in the art will recognize that nearly any code, unique or otherwise, can be used for link 155 beyond those described above, all of which are contemplated.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of distributing an issue of a magazine, the method comprising
printing a copy of an issue of a magazine;
packaging a collectible with the copy into a package where the collectible includes a link to on-line content corresponding to printed content of the magazine; and
sending the package to an individual.

2. The method of claim 1, wherein the collectible is removeably affixed to the copy.

3. The method of claim 1, wherein the collectible comprises a rendering of a cover of a published issue of the magazine.

4. The method of claim 1, wherein the collectible comprises an advertisement on a surface of the collectible.

5. The method of claim 1, wherein the link comprises a computer readable code.

6. The method of claim 5, wherein the computer readable code includes at least one of a barcode, an RFID tag, and a magnetic stripe.

7. The method of claim 1, wherein the link comprises a URL.

8. The method of claim 1, wherein the individual is a subscriber.

9. The method of claim 8, wherein the link received by the subscriber comprises a unique code associated only with the subscriber.

10. The method of claim 1, wherein the collectible comprises a substantially planar object.

11. The method of claim 10, wherein the planar object comprises card stock.

12. The method of claim 1, wherein the collectible comprises a non-planar object.

13. The method of claim 1, wherein the collectible has a rarity.

14. The method of claim 1, wherein the collectible is a member of a set.

15. The method of claim 1, wherein the printed content corresponds to printed content of the issue.

16. The method of claim 1, wherein the printed content corresponds to printed content of a previous issue of the magazine.

17. The method of claim 1, wherein the step of sending the package includes sending the collectible to the individual separately from the copy.
